(19) United States
(12) Patent Application Publication
(10) Pub. No.: US 2005/0078911 A1
(43) Pub. Date: Apr. 14, 2005

(54) System and method for using a concentric spectrometer to multiplex or demultiplex optical signals

(76) Inventors: Thomas L. Mikes, Ashby, MA (US); Lian Xing, Acton, MA (US)

Correspondence Address: Agilent Technologies, Inc.;Legal Department, DL 429, Intellectual Property Administration, P.O. Box 7599, Loveland, CO, 80537-0599, US

(21) Appl. No.: 10/685,270

(22) Filed: Oct. 14, 2003

(51) Int. Cl. G02B 6/34

(52) U.S. Cl. 385/37; 385/17; 385/24

(57) ABSTRACT

A multiplexing or demultiplexing system comprises an optical fiber interface and a concentric spectrometer coupled to the optical fiber interface. The concentric spectrometer multiplexes or demultiplexes optical signals and subjects such optical signals to a relatively low amount of optical aberrations. Thus, using the concentric spectrometer to multiplex or demultiplex optical signals within an optical network helps to reduce spreading of the channels within the optical network.

### BACKGROUND

Optical networks often employ wavelength division multiplexing (WDM) to transmit multiple optical signals using a single optical transmission path. In WDM, an optical multiplexing system spatially overlaps several quasi-monochromatic component optical signals to form a multi-wavelength optical signal. Each of the component optical signals occupies a wavelength range that does not overlap with the wavelength ranges occupied by the other component optical signals. Each non-overlapping wavelength range occupied by a component optical signal is often referred to as a “channel,” and the wavelength range occupied by the multi-wavelength optical signal is often referred to as the “system bandwidth.”

If each of the component optical signals were truly monochromatic and had zero wavelength tolerance, then it would theoretically be possible to provide an infinite number of channels within a finite system bandwidth. However, in reality, since each component optical signal is quasi-monochromatic and occupies a range of wavelengths, the system bandwidth can only be divided into a finite number of channels. Additionally, optical scattering properties of light in a transmission medium further increase the wavelength range of a component optical signal thereby increasing the channel bandwidth required to accommodate the component optical signal. An increase in the channel bandwidths to accommodate the increased bandwidths of component optical signals is often referred to as spreading of the channels. Such spreading of the channels further reduces the number of channels available in a given system bandwidth.

Moreover, in a typical optical network, a conventional optical multiplexing system at a network node spatially overlaps component optical signals in different channels into a multi-wavelength optical signal. The multiplexing system then transmits the multi-wavelength optical signal through an optical transmission path, such as an optical fiber, to another network node. At the other network node, an optical demultiplexing system normally receives the multi-wavelength optical signal and spatially separates the multi-wavelength optical signal into its constituent component optical signals. Note that the term “wavelength division multiplexing,” in a general sense, may be used to refer either to the multiplexing performed at the one network node or the demultiplexing performed at the other network node.

Unfortunately, conventional wavelength division multiplexing systems introduce optical aberrations, which further increase the wavelength range occupied by each component optical signal. Such increase in the wavelength ranges of the component optical signals necessitates additional spreading of the channels and a further reduction in the number of available channels.

### SUMMARY

The present invention generally pertains to a system and method for using a concentric spectrometer to multiplex or demultiplex optical signals.

Briefly described, one embodiment of a multiplexing or demultiplexing system comprises an optical fiber interface and a concentric spectrometer coupled to the optical fiber interface. The concentric spectrometer multiplexes or demultiplexes optical signals and subjects such optical signals to a relatively low amount of optical aberration. Thus, using the concentric spectrometer to multiplex or demultiplex optical signals within an optical network helps to reduce spreading of the channels within the network.

### BRIEF DESCRIPTION OF THE DRAWINGS

The invention can be better understood with reference to the following drawings. The elements of the drawings are not necessarily to scale relative to each other, emphasis instead being placed upon clearly illustrating the invention. Furthermore, like reference numerals designate corresponding parts throughout the several views.

FIG. 1 is a block diagram illustrating an optical network.

FIG. 2 is a block diagram illustrating two of the network nodes depicted in FIG. 1.

FIG. 3 is a flowchart illustrating a multiplexing process performed by a multiplexing system depicted in FIG. 2.

FIG. 4 is a flowchart illustrating a demultiplexing process performed by a demultiplexing system depicted in FIG. 2.

FIG. 5 is a diagram illustrating an exemplary concentric spectrometer that may be used in the multiplexing or demultiplexing systems depicted in FIG. 2.

FIG. 6 is a diagram illustrating a detailed view of the demultiplexing system depicted in FIG. 2.

FIG. 7 is a diagram illustrating a portion of an aberration-corrected concentric diffraction grating for use in the concentric spectrometer depicted in FIG. 5.

FIG. 8 is a diagram illustrating a more detailed view of the multiplexing system depicted in FIG. 2.

### DETAILED DESCRIPTION

The present invention generally pertains to a system and method for performing wavelength division multiplexing (WDM). In this regard, a WDM system receives optical signals and uses a concentric spectrometer, which will be described in more detail below, to multiplex or demultiplex the optical signals. Using a concentric spectrometer helps to reduce optical aberrations (e.g., spherical aberrations, astigmatism, distortions due to field curvature, coma, etc.) to which the component optical signals are subject, thereby helping to reduce spreading of the channels. A reduction in the spreading of the channels permits division of the system bandwidth into a greater number of channels.

FIG. 1 depicts an exemplary optical network 10. The network 10 has multiple nodes 52 interconnected via optical fibers 110. Each node 52 may receive an optical signal from any optical fiber 110 coupled to it, and each node 52 may transmit an optical signal to another node 52 through an optical fiber 110 optically coupled to both nodes 52.

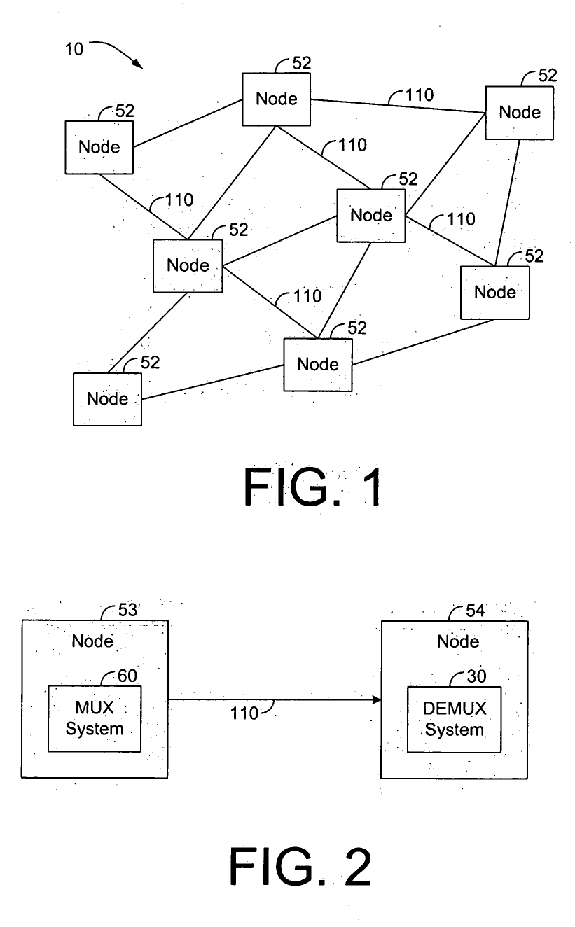

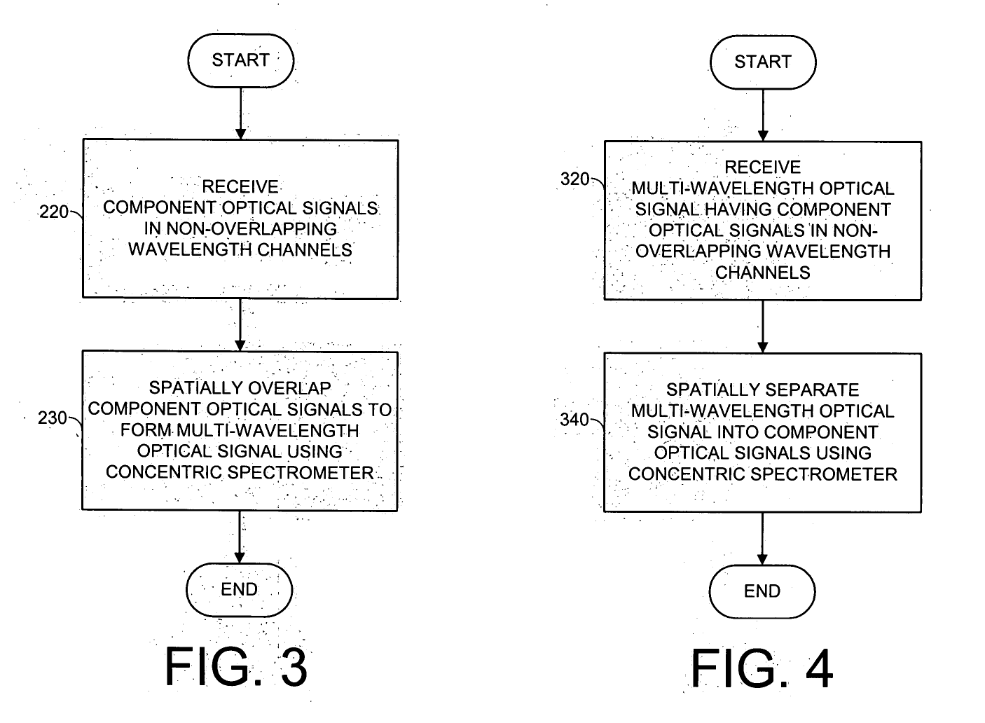

To increase the information carrying capacity of the network, the nodes 52 incorporate optical multiplexing and demultiplexing systems for performing wave division multiplexing (WDM). As an example, to enable the communication of optical signals between exemplary nodes 53 and 54 using WDM, one of the nodes 54 incorporates a demultiplexing (DEMUX) system 30, and the other node 53 incorporates a multiplexing (MUX) system 60, as shown by FIG. 2. Both MUX system 60 and DEMUX system 30 incorporate a concentric spectrometer. As shown by FIG. 3, the optical multiplexing system 60 receives multiple component optical signals (block 220) and spatially overlaps the multiple component optical signals into a single multi-wavelength optical signal (block 230) using a concentric spectrometer. After forming the multi-wavelength optical signal, the multiplexing system 60 then directs the multi-wavelength optical signal toward an optical fiber 110, which transmits the multi-wavelength optical signal to the other node 54. As shown by FIG. 4, the demultiplexing system 30 at this other node 52 receives (block 320) and spatially separates (block 340) the original component optical signals from one another using a concentric spectrometer. If desired, the node 54 may transmit, using similar techniques, one or more of the component optical signals to one or more other nodes 52 in the network 10. Moreover, the network 10 routes each optical signal in the foregoing manner until the signal arrives at its destination.

As will be described in more detail below, the DEMUX system 30 and the MUX system 60 both incorporate a concentric spectrometer for, respectively, spatially separating and spatially overlapping optical signals. A concentric spectrometer is a well-known device commonly used to divide incident light into its spectral components for enabling analysis of the incident light.

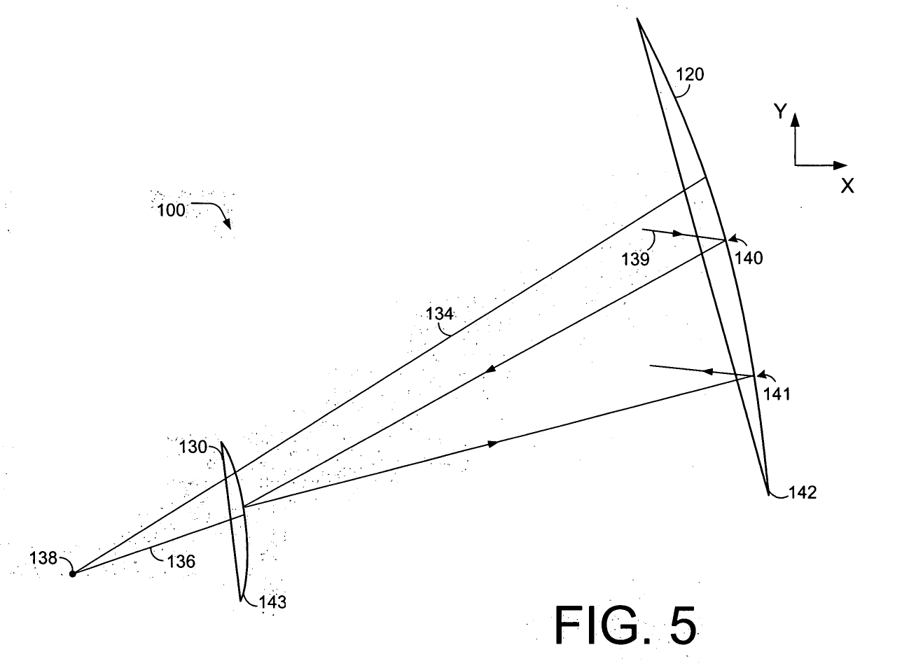

As shown by FIG. 5, a concentric spectrometer 100 is composed of a concave reflective device 120 and a convex diffraction grating 130. The spectrometer 100 is concentric in the sense that the center of curvature of the reflective device 120 and the center of curvature of a convex diffraction grating 130 are substantially co-located. In this regard, FIG. 5 depicts the radius of curvature 134 of the reflective device 120 and the radius of curvature 136 of the diffraction grating 130. Point 138 represents the common centers of curvature of the reflective device 120 and the diffraction grating 130. As shown by FIG. 5, each of the radii of curvature 134 and 136 ends at point 138.

Substantially co-located centers of curvature distinguish concentric spectrometers 100 from other types of spectrometers (i.e., non-concentric spectrometers). Such co-locating significantly reduces optical aberrations in the spectra generated by a concentric spectrometer compared to spectra generated by non-concentric spectrometers, as will be further explained below.

The reflective device 120 and diffraction grating 130 are arranged such that light traveling along an optical path 139 is reflected between the reflection device 120 and the diffraction grating 130 multiple times. In particular, the light strikes the concave surface of the reflective device 120, which reflects (reflection 140) and focuses the light toward the diffraction grating 130. Note that the focal point of the light being reflected by the reflection device 20 may be beyond the diffraction grating 130 such that the light reaches the diffraction grating 130 before reaching the focal point. The diffraction grating 130 diffracts the light toward the reflection device 120, which again reflects the light (reflection 141).

The reflection of light by any reflective surface introduces optical aberrations. However, when the centers of curvature of the reflective device 120 and the diffraction grating 130 are substantially co-located, the optical aberrations introduced by reflections 140 and 141 tend to cancel each other out. Indeed, depending on various factors, such as the angular relationship between reflective device 120 and diffraction grating 130, the focal points of reflections 140 and 141, the distance between reflective device 120 and diffraction grating 130, and the locations of the centers of curvature of the reflective device 120 and the diffraction grating 130, it is possible for the optical aberrations introduced by a first reflection 140 to be substantially canceled by the optical aberrations introduced by a second reflection 141.

Moreover, to minimize the total optical aberrations introduced by the concentric spectrometer 100, the reflective device 120 and the diffraction grating 130 may be arranged to maximize the degree to which the optical aberrations introduced by reflection 141 cancels the optical aberrations introduced by reflection 140. Techniques for arranging two reflective devices within a concentric spectrometer to enhance optical aberration cancellation are generally known in the art.

For example, it is generally well-known that having approximately a 1:2 ratio between the radii of curvatures of the two reflective devices within a concentric spectrometer helps to enhance cancellation of optical aberrations. Thus, to increase cancellation of optical aberrations, thereby reducing the total optical aberrations introduced by concentric spectrometer 100, the reflective device 120 and the diffraction grating 130 may be arranged such that the radius of curvature 134 is approximately twice as long as the radius of curvature 136. However, if desired, other ratios between the radius of curvature of the diffraction grating 130 and the radius of curvature of the reflective device 120 are possible.

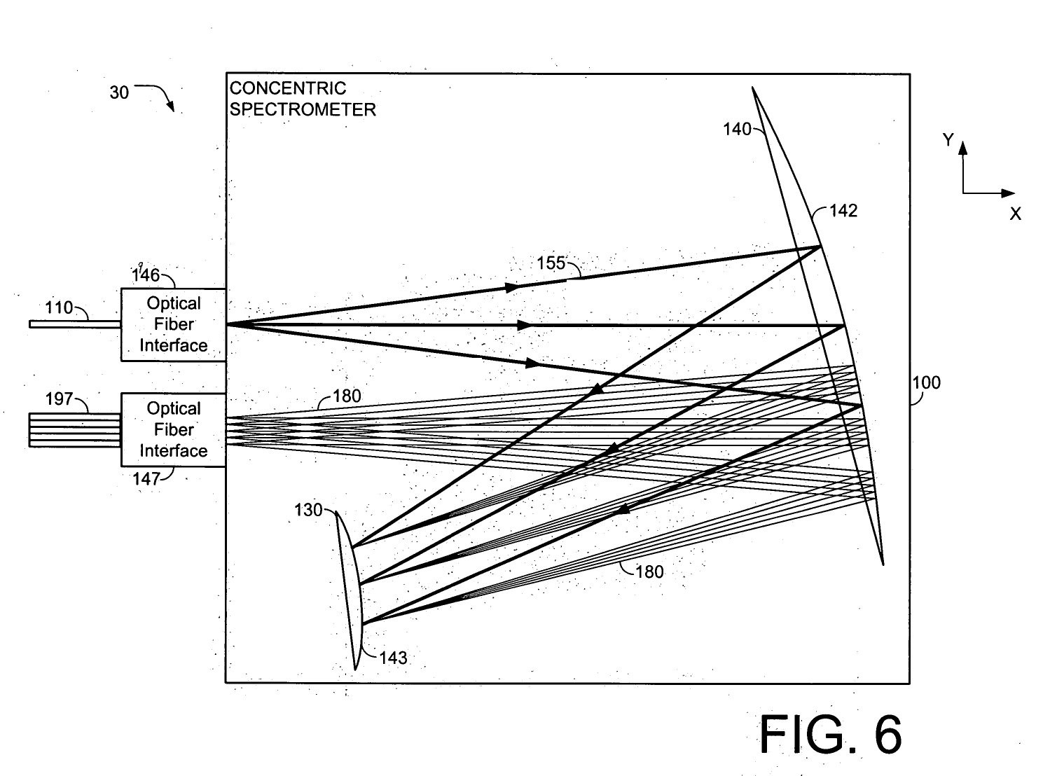

FIG. 6 illustrates a detailed view of an exemplary embodiment of the optical demultiplexing system 30 described above. The demultiplexing system 30 is composed of a concentric spectrometer 100 optically coupled to at least one optical fiber 110 of the network 10 (FIG. 1) and to at least one array 197 of optical fibers of the network 10. In the embodiment depicted by FIG. 6, the concentric spectrometer 100 is coupled to optical fiber interfaces 146 and 147. The optical fiber interface 146 is coupled to an end of the optical fiber 110 and holds this fiber in a fixed position with respect to diffraction grating 130, reflective device 140, and optical fiber interface 147. The optical fiber interface 147 is coupled to ends of the optical fiber array 197 and holds this array 197 in a fixed position with respect to diffraction grating 130, reflective device 140, and optical fiber interface 146. Note that various known or future-developed devices for receiving and holding ends of optical fibers may be used to implement optical fiber interfaces 146 and 147. As a mere example, a device commonly referred to as as a “V groove array” may be used to implement optical fiber interfaces 146 and 147.

When the optical fiber 110 and the array 197 are respectively coupled to optical fiber interfaces 146 and 147, as shown by FIG. 6, the fiber 110 and the array 197 are precisely aligned with respect to each other and with respect to the concentric spectrometer 100 such that a multi-wavelength optical signal emitted from the fiber 110 is demultiplexed by the concentric spectrometer 100, as will be described in more detail below, and received by the array 197. In this regard, the concentric spectrometer 100 receives a multi-wavelength optical signal 155 from the optical fiber 110 coupled to the optical interface 146. The multi-wavelength optical signal 155 is composed of multiple quasi-monochromatic component optical signals, and the concentric spectrometer 100 spatially separates the received multi-wavelength optical signal 155 into its component optical signals 180.

The concave surface 142 of the reflective device 120 is mirrored. The mirrored surface 142 reflects and focuses the multi-wavelength optical signal 155 diverging from the end of fiber 110 toward the diffraction grating 130. The convex surface 143 of the diffraction grating 130 has a plurality of grooves (not shown in FIG. 6) patterned, as will be described in more detail below, to disperse the multi-wavelength optical signal 155 striking the grating's surface 143. Thus, in reflecting the multi-wavelength optical signal 155, the convex surface 143 of the diffraction grating. 130 disperses the multi-wavelength optical signal 155 thereby angularly separating the multi-wavelength optical signal 155 into its component optical signals 180. These component optical signals 180 strike the reflective device 120, which reflects and focuses the component optical signals 180 toward the array 197 of optical fibers 110 coupled to the optical interface 147. The reflective device 120 and diffraction grating 130 are arranged such that optical aberrations introduced by the reflection of the component optical signals 180 by the reflective device 120 substantially cancel the optical aberrations introduced by the reflection of the multi-wavelength optical signal 155 by the reflective device 120.

As described above, by canceling optical aberrations introduced by the reflection of optical signals by the reflective device 120, the concentric spectrometer 100 introduces significantly less aberration (e.g., less spherical aberration, less astigmatism, less distortion due to field curvature, and less coma) than the non-concentric spectrometers that are conventionally used in optical demultiplexers. By introducing less aberration, the concentric spectrometer 100 can be used to multiplex or demultiplex optical signals of an optical network 10 with less spreading the channels of the network 10. Thus, using the concentric spectrometer 100 instead of a non-concentric spectrometer to demultiplex or multiplex optical signals within a network 10 permits the fibers of the network 10 to carry a greater number of channels within a given bandwidth.

Note that, if desired, an optical interface device (not shown) may be positioned to receive the component optical signals 180. This optical interface device may be structured to selectively route different component optical signals 180 to different optical fibers 110. For example, such an optical interface device may initially route a component optical signal 180 of a particular wavelength to a first optical fiber 110 of the array 197. However, at some point, it may be desirable to route the component optical signal 180 of the same wavelength to a different fiber 110 of the array 197. The optical interface device may comprise an optical switch (not shown) to control which of the optical fibers 110 of the array 197 receives the foregoing component optical signal 180. In addition, the optical interface device may comprise an optical multiplexer (not shown) to spatially overlap selected ones of the component optical signals 180 into another multi-wavelength optical signal for transmission through optical network 10.

Various types of diffraction gratings are known in the art and may be used as the diffraction grating 130 to separate the multi-wavelength optical signal 155 into its component optical signals 180. Many conventional diffraction gratings have straight grooves that are linearly spaced across the grating's surface such that the distance between adjacent grooves is substantially constant across the grating's surface. However, by using a grating having curved grooves instead of straight grooves to diffract the light, it is possible to enhance the optical power of the diffracted light and to reduce aberrations in the diffracted light. Aberrations may be further reduced by spacing the grating grooves non-linearly such that the distance between adjacent grooves varies across the grating surface. Diffraction gratings having curved grooves and/or non-linearly spaced grooves to help reduce optical aberrations shall be referred to herein as “aberration-corrected” gratings. Aberration-corrected gratings and techniques for manufacturing such gratings are described in more detail in U.S. Pat. No. 6,266,140, which is incorporated herein by reference.

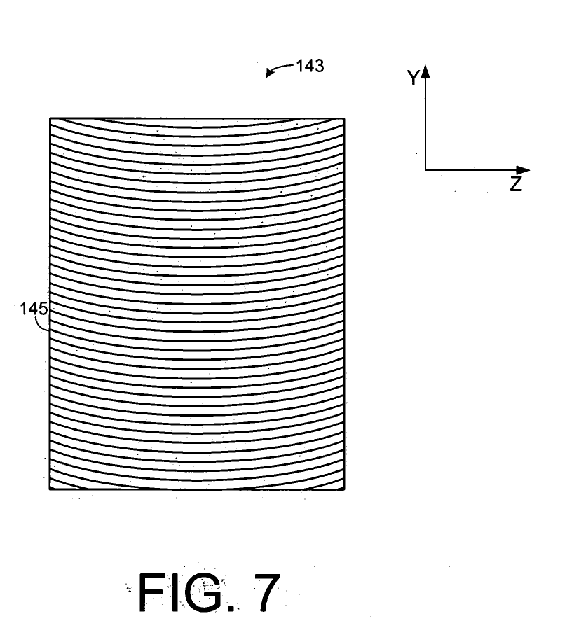

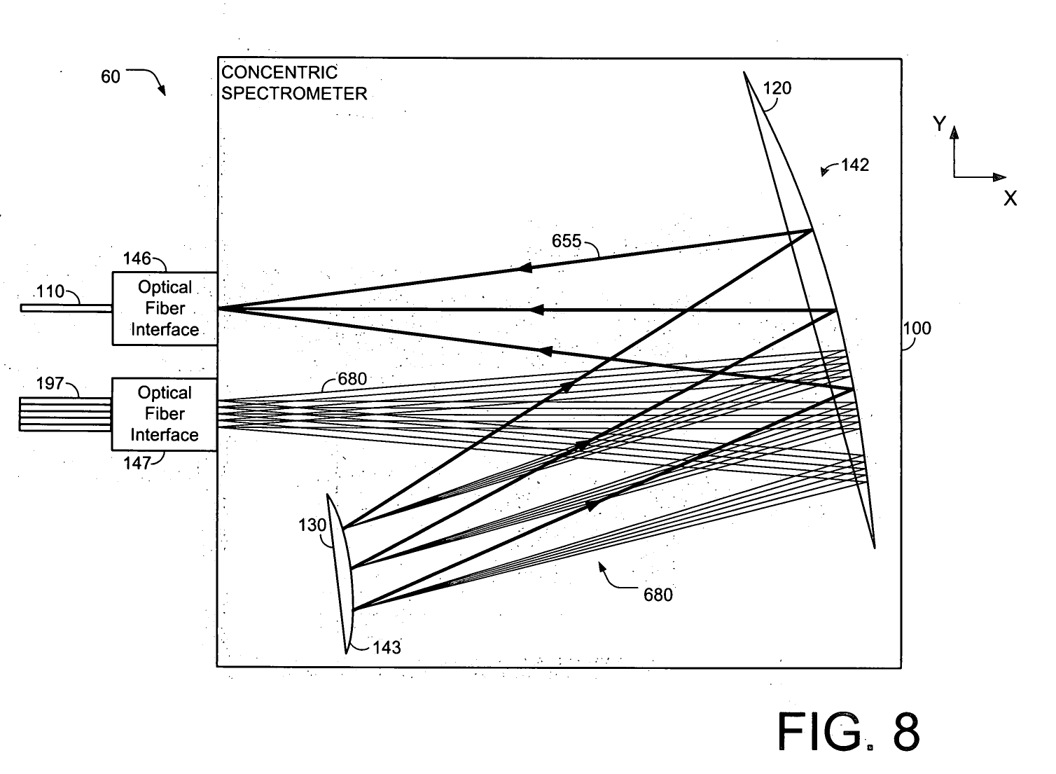

In one exemplary embodiment, the diffraction grating 130 is aberration-corrected and, as shown by FIG. 7, has curved grooves 145 etched, milled, or otherwise formed in the surface 143. As described above, the curved grooves 145 provide additional optical power and help to improve correction of aberrations, compared to diffraction grating surfaces with substantially straight grooves.

FIG. 8 illustrates a detailed view of an exemplary embodiment of the optical multiplexing system 60 described above with reference to FIG. 2. As shown by FIG. 8, the optical multiplexing system 60 is composed of a concentric spectrometer 100 optically coupled to an optical fiber 110 and array 197 of optical fibers of the network 10 (FIG. 1). Similar to the optical demultiplexing system 30 of FIG. 6, the concentric spectrometer 100 of the multiplexing system 60 is coupled to optical interfaces 146 and 147, which respectively hold an end of the optical fiber 110 and ends of the array in a fixed position relative to each other and relative to the concentric spectrometer 100.

The concentric spectrometer 100 spatially overlaps component optical signals 680 to form a multi-wavelength optical signal 655. Note that the components of the optical multiplexing system 60 of FIG. 8 are identical to the components of the optical demultiplexing system 30 of FIG. 6. However, the direction of light propagation is reversed for the optical multiplexing system 60.

Thus, in operation, an array 197 of optical fibers 110 of the network 10 (FIG. 1) transmits each of the component optical signals 680 towards the reflective device 120. Note that it is possible for at least one of the fibers 110 of the array 197 to transmit a multi-wavelength optical signal. In such a case, an optical demultiplexer (not shown) may be used to spatially separate the multi-wavelength optical signal into its component optical signals 680, which are then transmitted to the reflective device 120.

The reflective device 120 reflects and focuses the component optical signals 680 toward diffraction grating 130. In one exemplary embodiment, the diffraction grating 130 is aberration-corrected to further reduce optical aberrations. The patterning of the grooves of the diffraction grating 130 is such that diffraction of the component optical signals 680 by the grating's surface 143 spatially overlaps the signals 680 into a multi-wavelength optical signal 655. The multi-wavelength optical signal 655 strikes the reflective device 120, which reflects this multi-wavelength optical signal 655 toward optical fiber 110. The optical fiber 110 then transmits the multi-wavelength optical signal 655 to another node 52 of the network 10. At this network node 52, an optical demultiplexing system 30 (FIG. 6) may demultiplex the multi-wavelength optical signal 655, using the techniques previously described above or otherwise, to recover the component optical signals 680.

The reflective device 120 and diffraction grating 130 are arranged such that optical aberrations introduced by the reflection of the multi-wavelength optical signal 655 by the reflective device 120 substantially cancel the optical aberrations introduced by the reflection of the component optical signals 680 by the reflective device 120. Thus, the concentric spectrometer 100 in the optical multiplexing system 60 helps to reduce optical aberrations to which the component optical signals are subject by the demultiplexing process performed by the system. 60. By reducing aberrations, the concentric spectrometer 100 reduces the spreading of channels, thereby permitting a greater number of channels within the system bandwidth of the optical transmission path, such as the optical fiber 110, carrying the multi-wavelength optical signal 655.

It should be noted that the embodiments of a concentric spectrometer described above have a reflective device 120 that is concave and a diffraction grating 130 that is convex. However, in other embodiments, the concentric spectrometer may have a convex reflective device and a concave diffraction grating.

1. A system for multiplexing or demultiplexing optical signals, comprising:
an optical fiber interface; and
a concentric spectrometer coupled to the optical fiber interface.

2. The system of claim 1, wherein the concentric spectrometer and optical interface are arranged such that the concentric spectrometer receives a multi-wavelength signal from an optical fiber coupled to the optical fiber interface and spatially separates the multi-wavelength optical signal into its constituent component optical signals.

3. The system of claim 1, wherein the concentric spectrometer and optical interface are arranged such that the concentric spectrometer receives component optical signals from optical fibers coupled to the optical fiber interface and spatially overlaps the component optical signals into a multi-wavelength optical signal.

4 The system of claim 1, wherein the concentric spectrometer comprises an aberration-corrected diffraction grating.

5. The system of claim 1, wherein the optical fiber interface is coupled to an optical fiber such that the optical fiber is optically coupled to the concentric spectrometer.

6. A method for demultiplexing optical signals, comprising:
providing a concentric spectrometer;
receiving a multi-wavelength optical signal at the concentric spectrometer; and
spatially separating the multi-wavelength optical signal into its constituent component optical signals using the concentric spectrometer.

7. The method of claim 6, wherein the concentric spectrometer comprises an aberration-corrected diffraction grating.

8. A method for multiplexing optical signals, comprising:
providing a concentric spectrometer;
receiving component optical signals at the concentric spectrometer; and
spatially overlapping the component optical signals into a multi-wavelength optical signal using the concentric spectrometer.

9. The method of claim 8, wherein the concentric spectrometer comprises an aberration-corrected diffraction grating.
